(19) United States
(12) Patent Application Publication
(10) Pub. No.: US 2002/0076221 A1
(43) Pub. Date: Jun. 20, 2002

(54) Method and apparatus for discharging effluent from a photographic process

(76) Inventor: Michael McDonell, Barrie (CA)

Correspondence Address: Todd D. Bailey, Bereskin & Parr, Box 401, 40 King Street West, Toronto, CA

(21) Appl. No.: 09/735,800

(22) Filed: Dec. 14, 2000

(51) Int. Cl. G03D 3/00

(52) U.S. Cl. 396/564

(57) ABSTRACT

An apparatus for discharging effluent from a photographic process, such as developing liquid to a drain. The effluent can be, for example, de-silvered, spent fixer liquid, and spent developer liquid, which if mixed together, particularly in the presence of oxygen, form a solid iron oxide precipitate which becomes a sludge and eventually clogs pipes and drains. The apparatus includes two separate reservoirs for holding the liquids and two separate pumps for pumping the liquids to a drain, while reducing the risk of clogging in the pipes and drain from precipitate formation.

### FIELD OF THE INVENTION

The present invention relates to effluent discharge systems for use in photographic processing and, more particularly, to discharging spent fixer and developer liquids.

### BACKGROUND OF THE INVENTION

Various liquid compositions are employed in the commercial development of black and white and colour photographs. For example, a developer liquid is used to develop an exposed film and a fixer liquid is used to fix the developed image on the medium. The developer liquid is highly alkaline typically having a pH of 10 to 11, while the fixer liquid typically has a pH of 4.5 to 7.5. Both liquids are recycled in use until, after a certain number of cycles, their effectiveness decreases to the point where they are considered to be “spent”.

During the development process, ions of silver accumulate in the fixer liquid. The silver is recovered from the fixer liquid by an exchange process which ultimately adds additional iron to the iron ions already present in the fixer liquid. When the fixer liquid is finally spent, it is non-toxic and thus may be disposed of in the municipal drainage system. This is also the case with spent developer.

However, when these two fluids are mixed, ammonia is formed which acts as a breeding ground for bacteria which form a sludge sometimes referred to as “Bio-Slime”. This sludge, together with the iron oxide precipitation which occurs when the fixer is exposed to atmospheric oxygen, tends to clog hoses in the apparatus and drains, etc. While machinery and conduits can be regularly maintained, many photographic processing facilities have only a single drain leading to the municipal system, and hence mixing of these chemicals is unavoidable. Most clogging occurs in the local access to the municipal system, however, and not in the municipal system itself because, while the local access may have a conduit size of 4 inches in diameter or less, the municipal conduits are much larger and thus more resistant to clogging.

In one attempt to solve the problem of drain clog, Canadian Patent No. 2,261,557 to Brunelle et al. discloses a photographic effluent discharge system in which spent fixer and developer are mixed in a holding container and then pumped via a venturi mechanism at high speed to the drain. Pumping the fixer-developer in this manner causes the precipitate in the liquid combination to be forced into the municipal drain at high speed, thereby attempting to ensure that the precipitate is not permitted to reside in the local access conduit, but rather is forced out to the larger municipal drainage conduit.

The device of Brunelle et al., however, requires that the fixer and developer liquids be mixed in the holding container and sludge inevitably forms and clogs the device. Also, the piping in the device located downstream of the holding container is also exposed to the sludge and thus is susceptible to clogging and must be periodically cleaned.

Accordingly, there is a need for an apparatus and method for discharging effluent from a photographic process which reduces the tendency for sludge formation and its consequent clogging effect.

### SUMMARY OF THE INVENTION

In a first aspect, the present invention provides an apparatus for discharging effluent from a photographic process, the effluent comprising at least two liquids, the apparatus comprising a first reservoir for receiving a first liquid, the first reservoir having a first evacuator for evacuating the first liquid from the first reservoir, and a second reservoir for receiving a second liquid, the second reservoir having a second evacuator for evacuating the second liquid from the second reservoir.

In a second aspect, the present invention provides an apparatus for discharging effluent from a photographic process, the effluent comprising at least two liquids, the apparatus comprising a first reservoir for receiving a first liquid, the first reservoir having evacuation means for removing the first liquid from the first reservoir and transport means for transporting the removed first liquid to a drain, and a second reservoir for receiving a second liquid, the second reservoir having evacuation means for removing the second liquid from the second reservoir and transport means for transporting the removed second liquid to a drain.

In a third aspect, the present invention provides a method of disposing of a first liquid and a second liquid from a photographic processing machine, the method comprising pumping the first liquid to a drain, and pumping the second liquid to a drain, the first and second liquids not being permitted to mix until in the drain.

### DESCRIPTION OF THE DRAWING

The present invention will now be described by way of example only, with reference to the drawings in which:

FIG. 1 is a schematic view of an effluent discharging apparatus in accordance with a preferred embodiment of the present invention; and

FIG. 2 is a schematic view of an effluent discharging apparatus in accordance with an alternate embodiment of the present invention.

### DESCRIPTION OF THE PREFERRED EMBODIMENTS

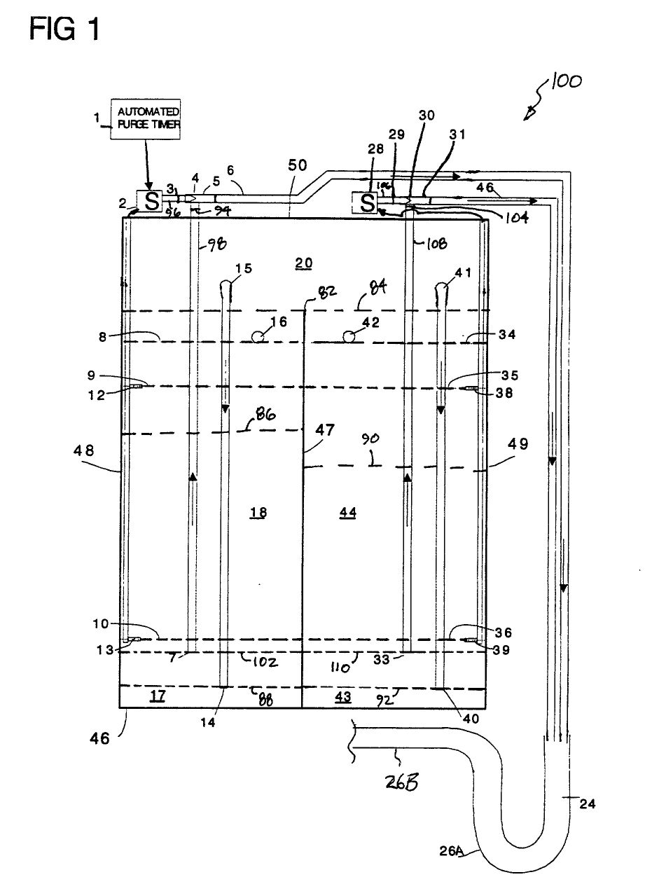

An effluent discharging apparatus in accordance with a preferred embodiment of the present invention is shown in FIG. 1 at 100. Apparatus 100 comprises a container or tank 48 having a floor 46, a surrounding wall 49 and a lid 50. A divider 47 divides tank 48 into two reservoirs 17 and 43, respectively, which are separate and prevent contact between their respective contents, as will be described in more detail below. A volume of air 20 is above the liquid in tank 48.

Reservoir 17 holds a fixer liquid 18 which has a liquid level 86. Reservoir 17 has a feed conduit 15 connected to a source of spent de-silvered fixer (not shown). Feed conduit 15 terminates at an inlet 14 positioned at a level 88 above floor 46. An emergency overflow is provided at 16. Inlet 14 is positioned at level 88 below a liquid low level 7 (described further below), to ensure that inlet 14 is always submerged in liquid 18. When fixer liquid is exposed to atmospheric air, iron oxide precipitation occurs and, thus, to avoid a clogging of inlet 14 it is preferable to protect inlet 14 from contact with air 20 by keeping it submerged.

Reservoir 17 has an outlet conduit 98 having an outlet 7 which is preferably spaced apart from floor 46 at a level 102 to minimize any interference with outlet 7 which may be caused by tank bottom 46. Outlet conduit 98 communicates with an evacuator such as a venturi 4 in this case, via a pump inlet 94. Venturi 4 also has a carrier liquid inlet 3 and an outlet 5. Carrier liquid inlet 3 is connected via conduit 96 to a carrier liquid source (not shown), preferably a typical municipal water line, such line having a typical delivery pressure of about 40 psi. Interposed in conduit 96 is a solenoid valve 2, described in more detail below. Outlet 5 communicates with a drain 24 through a discharge conduit 6. Drain 24 is preferably a typical municipal drain access having a P-trap 26A and a local access line 26B which leads to the municipal drainage system (not shown).

Venturi 4 is a typical fluid venturi and is sized to pump fixer liquid 18 at a high velocity and deliver the liquid to a drain, as will be described in more detail below.

Reservoir 17 is instrumented with a low liquid level sensor 13 and a high liquid level sensor 12 which are operatively connected with solenoid-operated valve 2 located upstream of venturi 4 on carrier liquid conduit 96. Also operatively connected to solenoid valve 2 is an automated timer 1.

Reservoir 43 is constructed and instrumented in a similar manner as reservoir 17. In particular, reservoir 43 holds a developer liquid 44, having a liquid level 90, and has a feed conduit 41 connected to a source of spent developer (not shown). Feed conduit 41 terminates at an inlet 40 positioned at a level 92 above floor 46. An emergency overflow is provided at 42. Leading from reservoir 43 in an outlet conduit 108 having an outlet 33, which is preferably spaced apart from floor 46 at a level 110. Outlet conduit 108 communicates with an evacuator or pump 30, a venturi 30 in this case, via a pump inlet 104. Venturi 40 also has a carrier liquid inlet 29 and an outlet 31. Carrier liquid inlet 29 is connected via conduit 106 to a carrier liquid source (not shown), preferably also a typical municipal water line. Venturi 4 is sized to adequately pump liquid from the disclosed apparatus at sufficient velocity to deliver the liquid to the municipal drainage system in a manner as disclosed herein. Interposed in conduit 106 is a solenoid valve 28, described in more detail below. Outlet 31 communicates with drain 24 through a discharge conduit 46. Reservoir 43 also has a low liquid level sensor 39 and a high liquid level sensor 38 which are operatively connected with solenoid-operated valve 28 located upstream of venturi 3 on carrier liquid conduit 106. Also operatively connected to solenoid valve 26 is a manual override switch (not shown).

In operation, liquid 18 is provided to reservoir 17 by inlet conduit 15 and rises to a level 86. When level 86 meets or exceeds a liquid level 9 in reservoir 17, high level sensor 12 senses the liquid level and triggers solenoid valve 2, which in turn opens to start a flow of carrier water through conduit 96 and into venturi 4. It will be understood that the flow of carrier water into venturi 4 causes a low pressure in the venturi, which in turn pumps liquid 18 from reservoir 17 by drawing liquid through outlet 7, up conduit 98 and into venturi 4 to mix with the carrier water. The carrier water and liquid 18 mixture exits the venturi through exit 5 and travels via conduit 6 to drain 24 and, ultimately to the municipal drainage system.

Pumping continues until level 86 drops to or below level 10, at which time low level sensor 13 senses the liquid level 86 and sends a signal to the solenoid valve 2 to turn off the flow of carrier water and thus stop the pumping of liquid 18 from reservoir 17. Thus, the liquid level 86 in reservoir 17 is maintained between levels 10 and 9.

If for some reason liquid level 86 rises beyond level 9 in reservoir 17, liquid 18 will simply drain out overflow 16 once it reaches level 8. Level 8 is lower than the level 84 of the top 82 of divider 47.

Also in the operation of apparatus 100, liquid 44 is provided to reservoir 43 by inlet conduit 41 and rises to a level 90. When level 90 meets or exceeds a liquid level 35 in reservoir 43, high level sensor 38 senses the liquid level and triggers solenoid valve 28, which in turn opens to start a flow of carrier water through conduit 106 and in into venturi 30. The induced low pressure in the venturi pumps liquid 44 into conduit 108 from outlet 33 to venturi 30, where it mixes with the carrier water. The carrier water and liquid 44 mixture exits the venturi through exit 31 and travels via conduit 46 to drain 24 and, ultimately to the municipal drainage system. Pumping continues until level 90 drops to or below level 36, at which time low level sensor 39 senses the liquid level 90 and sends a signal to the solenoid valve 28 to turn off the flow of carrier water and thus stop the pumping of liquid 44 from reservoir 43. Thus, the liquid level 80 in reservoir 43 is maintained between levels 35 and 36. If for some reason liquid level 90 rises beyond level 35, liquid 44 will simply drain out overflow 42 once it reaches level 34. Level 34 is lower than level 84.

The filling and evacuation of reservoirs 17 and 43 described above may occur at the same time or at different times. Preferably, their respective operation is governed by the liquid level sensors, such that the venturis may or may not be operating at the same time, depending on the condition of each.

Timer 1 is provided to permit solenoid valve 2 to be opened for a pre-selected period of time, an operation useful for the periodic purging of reservoir 17 substantially of spent fixer liquid 18, a regular maintenance operation well-known in the art with this type of apparatus. A manual override (not shown) is provided on solenoid valve 28 to the valve to be manually opened for a periodic purge or reservoir 43, a regular maintenance operation well-known in the art with this type of apparatus.

Spent fixer liquid 18 reacts with the oxygen in the air 20 which produces iron oxide precipitate, albeit at a relatively slow rate. Thus a regular build-up of precipitate occurs in reservoir 17 over time. Purging reservoir 17 clears away the precipitate. Preferably, timer 1 is set to operate valve 2 once per day, to ensure that reservoir 17 empties at least that frequently. Alternately, timer 1 can be set to operate valve 2 at other time intervals. Preferably, to save wasting carrier liquid, timer 1 opens valve 2 for a minimum amount of time while still ensuring that reservoir 17 is evacuated down to level 102. As well, since timer 1 will usually be used when apparatus 100 will be unsupervised for relatively long periods of time by personnel, minimizing the amount of time that timer 1 actuates venturi 4 minimizes any damage to the photographic processing facilities if there is a problem with apparatus 100 for some reason, such as discharge hose 6 or 46 becoming disconnected from drain 24.

The components of tank 48 and its feed conduits, etc. may be made from any material which does not degrade when exposed to the liquids to be used therein. Preferably, a suitable plastic is used.

Thus, the present invention provides an effluent discharging apparatus having separate reservoirs and which ensures that mixing of the liquids does not occur until the liquids enter the drain. This is advantageous in that the small diameter conduits and other parts of the apparatus do not clog with precipitate, reducing maintenance requirements significantly. Further, when a high velocity pump is used, clogging in the drain can be significantly reduced.

The apparatus and method of the present invention can be used for discharging effluent from both colour and black and white photographic processes, as well as x-ray processes.

As will be apparent to persons skilled in the art, various modifications and adaptations of the systems and methods described above are possible without departure from the scope of the appended claims.

Apparatus 100 may optionally further include a floating plate (not shown) which floats on the top surface of fixer liquid 18, occupying as much of the top surface as possible, to prevent contact of the fixer liquid 18 with air volume 20, and therefore reduce the rate of production of precipitate.

Utilizing reservoirs 17 and 43 to hold spent fixer and developer liquids 18 and 44, allows the volumes of the two liquids to build up to a point where a small venturi can pump them without excessive use of carrier liquid. However, reservoirs 17 and 43 may be omitted and venturi 4 and 30 may be connected directly to sources of the two spent fixer and developer liquids, respectively. This configuration is less preferable, however, because it tends to result in higher consumption of carrier liquid per unit volume of liquid pumped.

The present invention may also be used with advantage in discharging any liquids or fluids used in photographic processing, especially where preventing the mixing of at least two liquids is desired. Also, one skilled in the art will appreciate that more than two reservoir +venturi assemblies may be provided where more than two fluids are to be pumped.

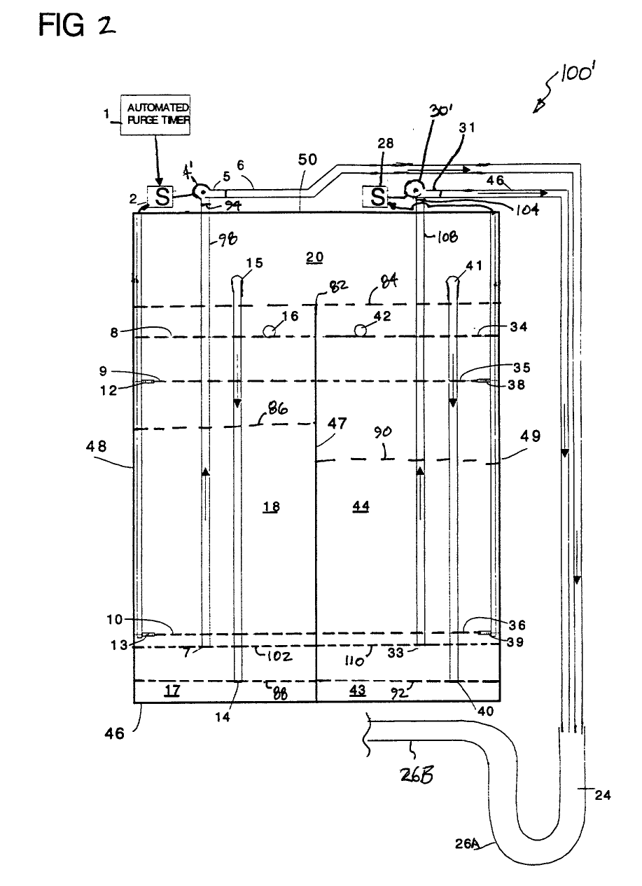

While a venturi is the preferred means of pumping, any other pumping means or evacuation means will work, such as a liquid pump. For example, referring to FIG. 2, the evacuator or evacuation means of the present invention may alternately comprise a pump 4′ and/or pump 30′. (It will be understood that all other elements of apparatus 100′ of FIG. 2 are substantially as described above, and therefore represented by the same reference numerals.) Alternately, a venturi may be used in association with one reservoir only (preferably the fixer liquid, as will be understood by one skilled in the art), while the other reservoir may be evacuated using another type evacuation means, such as a pump, or simply by gravity. Irrespective of the evacuation means employed, it is preferable to dilute the effluent, with a carrier liquid or otherwise, to further reduce the possibility of clogging within the system.

A filter (not shown) may be provided to cover outlets 7 and/or 33. Reservoirs 17 and 43 need not be in a single container, but may alternately be provided in separate containers. The manual and automatic purge features are desired but also not essential to the operation of the apparatus described.

Still other modifications and adaptations of the apparatus and methods described above will be apparent to those skilled in the art but which do not depart from the scope of the appended claims.

I claim:

1. An apparatus for discharging effluent from a photographic process, said effluent comprising at least two liquids, the apparatus comprising:
a first reservoir for receiving a first liquid, said first reservoir having a first evacuator for evacuating said first liquid from said first reservoir; and
a second reservoir for receiving a second liquid, said second reservoir having a second evacuator for evacuating said second liquid from said second reservoir.

2. An apparatus as in claim 1, wherein said first evacuator is a pump.

3. An apparatus as in claim 1, wherein said first evacuator is a venturi.

4. An apparatus as in claim 1, wherein said second evacuator is a pump.

5. An apparatus as in claim 1, wherein said first liquid is a spent fixer liquid.

6. An apparatus as in claim 1, wherein said second liquid is a spent developer liquid.

7. An apparatus as in claim 1, wherein said first and second reservoirs are contained in a common container.

8. An apparatus as in claim 1, wherein said first and second evacuators are connected to a common drain source.

9. An apparatus as in claim 8, wherein said first evacuator is connected to said common drain source by a first conduit and said second evacuator is connected to said common drain source by a second conduit.

10. A method of disposing of a first liquid and a second liquid from a photographic processing machine, the method comprising:
pumping said first liquid to a drain; and
pumping said second liquid to a drain, said first and second liquids not being permitted to mix until in said drain.

11. A method as in claim 10, wherein said pumping of said first liquid is by a venturi.

12. A method as in claim 10, wherein said pumping of said second liquid is by a venturi.

13. A method as in claim 10, further comprising the step of feeding said first liquid to a first reservoir before pumping said first liquid to said drain.

14. A method as in claim 10, further comprising the step of feeding said second liquid to a second reservoir before pumping said second liquid to said drain.

15. A method as in claim 10, wherein said first liquid is spent developer liquid.

16. A method as in claim 10, wherein said second liquid is spent fixer liquid.

17. An apparatus for discharging effluent from a photographic process, said effluent comprising at least two liquids, the apparatus comprising: reservoir having evacuation means for removing said second liquid from said second reservoir and transport means for transporting said removed second liquid to a drain.

18. An apparatus as in claim 17, wherein said first reservoir transport means is a venturi.

19. An apparatus as in claim 17, wherein said first liquid is a spent developer liquid.

20. An apparatus as in claim 17, wherein said second liquid is a spent fixer liquid.
